(19) United States
(12) Patent Application Publication
(10) Pub. No.: US 2014/0123739 A1
(43) Pub. Date: May 8, 2014

(54) METHOD FOR TESTING PARTICULATE MATERIALS

(71) Applicant: Hongyu Luo, Action, MA (US)

(72) Inventor: Hongyu Luo, Action, MA (US)

(21) Appl. No.: 14/036,488

(22) Filed: Sep. 25, 2013

Related U.S. Application Data
(60) Provisional application No. 61/722,902, filed on Nov. 6, 2012.

(51) Int. Cl. G01N 15/02

(52) U.S. Cl. CPC G01N 15/02
USPC 73/87

(57) ABSTRACT

Methods of testing brittle particulate materials are described. In a preferred embodiment, a method includes characterizing the particle disintegration or breakage after a sample of brittle particle material is treated with a fluid or chemical. The particle disintegration may be characterized with visual observation. Imaging, or particle size measurement methods. In, another preferred embodiment, a method includes crushing 100-200 particles of a brittle particulate material for statistical analysis of its mechanical property. Un yet another preferred embodiment, a method includes analyzing the results of single particle crush of a brittle particulate material with Weibull distribution and using the product of the Weibull modulus and characteristic property as a unified measure of the mechanical property of the brittle particulate material.

### CROSS-REFERENCE TO RELATED APPLICATIONS

This application claims the benefit of U.S. Provisional patent application No. 61/722,902, filed on Nov. 6, 2012, under 35 U.S.C. §119(e).

### STATEMENT REGARDING FEDERALLY SPONSORED RESEARCH OR DEVELOPMENT

Not applicable

### REFERENCE TO MICROFICHE APPENDIX

Not applicable

### BACKGROUND OF THE INVENTION

1. Field of the Invention

The present invention generally relates to a method of testing brittle particulate materials, and more particularly to a method that measures the quality of brittle particles such as sands, man-made proppants, catalysts and catalyst carriers.

2. Background of the Invention

A number of industries use brittle particulate materials such as sand, ptomains, glass particles, catalysts and catalyst carriers. For example, proppant is critical fbr fracture conductivity and productivity of oil and/or gas wells stimulated by hydraulic fracturing. Proppant quality concerns not only the fracturing operation, but more importantly the success of the whole investment on the well. Proppant samples are usually evaluated in laboratories that conform to standards such as ISO 13503-2 and ISO 13503-5. In reality, however, real-time proppant quality management is lacking, largely because of technical reasons (e.g. lack of easy-to-execute and reliable techniques).

In ISO 13503-2, the acid solubility test is a standard one whereby a proppant sample is treated with a strong acid (12% HCl and 3% HF) and its acid solubility is measured by the percentage of weight loss after the acid treatment. In reality, many ceramic proppant particles will break apart in such strong acids and only a small portion will dissolve. By measuring the dissolved part only, the acid solubility overestimates the resistance of the sample to the strong acid, and underestimates its vulnerability to various other fluids. In fact, some ceramic proppants have been reported to be weakened by weak acids (LaFollette, et al., 2011). As such, the standard acid solubility test according to ISO 13503-2 is not a good method of evaluating the chemical resistance of proppants.

Proppant strength cannot be tested reliably in the field because the standard crush test according to ISO 13503-2 is usually done on a bulky press and subject to many error-causing factors such as personnel, equipment calibration and operating procedures. For example, U.S. Pat. No. 7,562,583 discloses a sophisticated loading device culled the pluviator to improve the loading of proppant samples into crush cells and reduce error due to loading. Such sophistication adds to the difficulty of conventional proppant crush tests. Conventional standard crush test has many other drawbacks. It is only applicable to non-coated proppants, so the strength of resin-coated proppants cannot be simply evaluated with a crush cell. It can only be used to test dry proppant samples although it has been widely known that water wetting will decrease the strength of dry and uncoated proppants, and in reality proppants will be in constant contact with fluids (fracturing fluids, production fluids or reservoir fluids). As such, conventional standard crush test can easily be misused (Palisch, et al., 2009).

Recently it was found that proppants may interact with formation fluids and rocks in a process called proppant diagenesis (Weaver, et al., 2010). The finding of proppant strength degradation due to diagenesis was based on “single particle crush test”, a method that has been used on proppants a few times (LaFollette, et al., 2011; Breval, et al., 1987; Luscher, et al., 2007) and by the catalysts and catalyst carriers industry as a standard method (ASTM D4179-11, 2011). Not only does the method have the potential for comparing two different proppants for selection purposes, it also can be readily used for quantifying the dynamic change of proppant strength due to its interaction with fluid/formation rocks in real or simulated reservoir conditions. Empirically only 20-30 proppant particles were handpicked and crushed (LaFollette, et al., 2011; Luscher, et al., 2007) for the sample under test, but the number of proppant particles that ought to be crushed for consistent results is an open question.

When analyzing the multiple single particle test results, Weibull distribution has been used to characterize the statistical variation in the fracture strength of brittle materials such as ceramics and glasses (ASTM C1239-07, 2007). The two characteristic parameters from a typical Weibull analysis are the Weibull modulus and characteristic mechanical property, whereby the Weibull modulus is a measure of the consistency of the single particle mechanical property distribution; and characteristic mechanical property is representative of the mechanical property of a typical single particle, much a “mean” or “average” mechanical property of the material of which the single particles are made. The higher the Weibull modulus is, the better the particulate material quality consistency. The higher the characteristic mechanical property is, the stronger the particulate material. Such two-parameter analysis makes it difficult to compare and rank the qualities of the materials of which different single particles are made. For example, one particulate material may have higher characteristic strength but lower Weibull modulus than another particulate material of similar type. Thus it is desirable to have only one parameter to compare and rank the mechanical qualities of the particulate materials that the tested single particles are representing.

When carrying out the single particle crush test, normally a small number of particles are randomly picked from a sample that has a large number of particles. For example, Weaver (2008) and Luscher (2007) used single particle crush tests in which they crushed 30 particles in each test. However, there is some variation to the test results when the test is repeated several times (Raysoni, et al., 2012). In order to make the test results reliable and feasible, it is necessary to find the optimum range of the number of particles to be crushed. Beyond the low number of the range, the Weibull modulus and characteristic strength shall stabilize. Blow the high number of the range, the single particle crush test shall be efficient and not time-consuming.

The purpose of the present invention is to disclose the optimum conditions of the single particle crush test method and an easy way to test the chemical resistance of brittle particles such as sands, proppants, catalysts and catalytic particles.

### SUMMARY OF THE INVENTION

Accordingly, the present invention teaches a method that can be used to easily characterize the chemical resistance of brittle particles by observing the existence or measuring the quantity of disintegrated particles after the said brittle particles are treated with a fluid or a chemical. Such a fluid or a chemical may include an acid, a base, or a fluid that simulates the chemistry of the real-time fluids such as those in oil and/or gas wells. Additionally, the fluid treatment of the sample may be carried out at various conditions such as high temperature and high pressure (HTHP).

The present invention provides the optimum range for the number of particles necessary and adequate in single particle crush tests for evaluating the mechanical properties of brittle particles. Below the said optimum range the single particle crush test results may be subject to significant variation and not reliable. Above the said optimum range, the single particle crush test may be too time-consuming and not practical.

The present invention also teaches a method of evaluating and ranking the mechanical qualities of particulate materials by analyzing the results of single particle crush tests on brittle particles using the Weibull distribution. The product of the Weibull modulus and the characteristic mechanical property is the combined factor indicating the mechanical quality of the particulate material of which the single particles are made. The said combined factor is the single number by which the mechanical qualities of particulate materials can be compared and ranked, thus providing an alternative and easy method for quality control and product improvement research.

### BRIEF DESCRIPTION OF THE DRAWINGS

FIG. 1 is a picture of a portion of a ceramic proppant sample after it is treated in an weakly acidic aqueous solution, whose pH is 3, at 200° F. for 12 hours. The portion is labeled as Sample G in single particle crush test results.

FIG. 2 is a picture of another portion of the same ceramic proppant sample after it is treated in an weakly acidic aqueous solution, whose pH is 4, at 170° F. for 12 hours. This portion is labeled as Sample H in single particle crush test results.

FIG. 3 is a picture of yet another portion of the same ceramic proppant sample after it is treated in water, whose pH is 7, at 200° F. for 12 hours. This portion is labeled as Sample E in single particle crush test results.

FIG. 4 is a picture of yet another portion of a ceramic proppant sample after it is treated in a basic aqueous solution, whose pH is 10, at 200° F. for 12 hours. This portion is labeled as Sample F in single particle crush test results.

FIG. 5 are two graphs that illustrates the Weibull analysis of single particle crush test results of Sample D, where in FIG. 5(A) is the linear regression and FIG. 5(B) the Probability density representation of FIG. 5(A) showing the strength distribution.

FIG. 6 are two graphs that illustrates the Weibull modulus (FIG. 6(A)) and characteristic crush strength (FIG. 6(B)) of Sample D change as a function of the number of particles as the single particle crush test progresses.

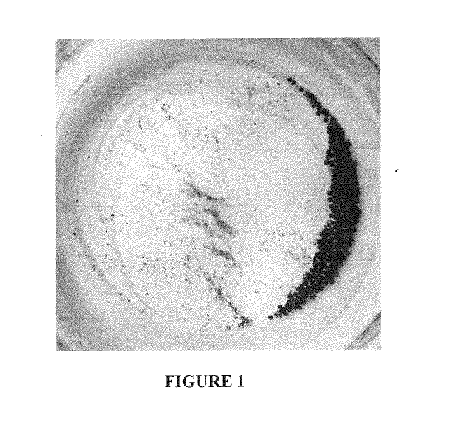

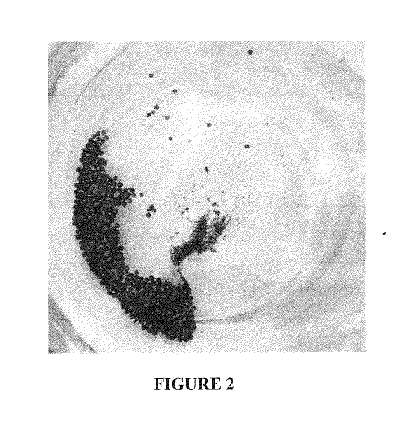

Table 1 is a summary of all the single particle crush test results.

Table 2 illustrates the comparison of the product of Weibull modulus and characteristic strength (m*σ₀).

### DETAILED DESCRIPTION OF THE INVENTION

The method of the present invention is illustrated with an example using a ceramic proppant sample received from an oil and gas field. The received sample (called Master Sample hereon) is an intermediate strength ceramic proppant with 20/40 mesh size, 3.2 g/cc specific gravity and 5˜10% acid solubility (tested according to standard methods in ISO 13502-2). The Master Sample is split into eight identical portions, each of which is on the order of 0.2 g (or about 300 particles), using a splitter described in ISO 13503-2 and a procedure known by the person having ordinary skill in the art.

The eight sample portions are labeled as Sample A. Sample B, . . . Sample H, each of which is then treated with conditions according to Table 1. The treatment fluids listed Table 1 is generally an aqueous fluid of that simulate the pH of the fracturing fluid or the reservoir fluid, at a moderate temperature for a duration that simulates the reservoir and production conditions. The treatment fluids were tap water with room temperature (RT) pH value of 6. acetic acid (CH₃COOH, CAS 64-19-7) water solution with RT pH value of 3 or 4, and a sodium carbonate (Na₂CO₃. CAS#497-19-8) water solution with RT pH value of 10. The fluid treating temperature and duration are also listed in Table 1.

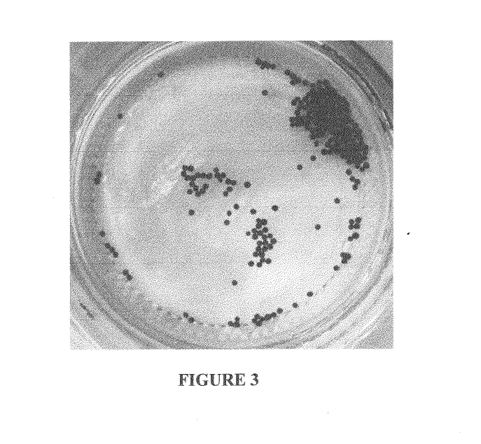

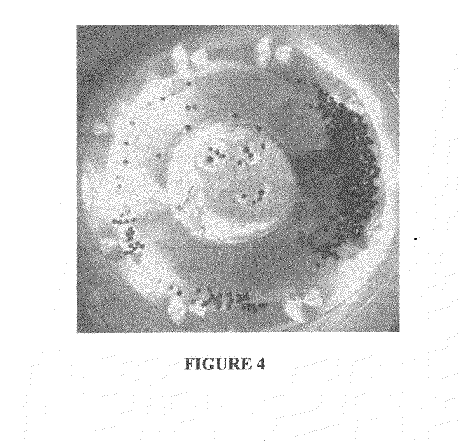

After the fluid treatment, each of the eight sample portions is examined visually and by photography. Right after fluid treatments and before single particle crush tests, it was visually observed that moderate-weak acidity and moderate temperature (170-200° F.) disintegrated some of the proppant particles in Samples G and H (FIG. 3). Acid attack is not evident at room temperature in one day (Sample D). The particle disintegration is an indication of the vulnerability of the sample under test to the chemical attack of weak acids. Such an indication is not evident in the standard tests of acid solubility according to ISO 13503-2.

The said particle disintegration is a phenomenon whereby spherical or nearly spherical particles break into irregularly-shaped particles, cleavages or fines of smaller sizes than the said spherical or nearly spherical particles, Particle disintegration may also be described as particle breakage, particle fall apart, etc, without departing from the spirit and scope of the invented method.

As noted above, one way of characterizing particle disintegration is by visual observation and photography. Particle disintegration may also be characterized using microscopes and other imaging methods without departing from the spirit and scope of the invention.

Another way of characterizing particle disintegration is by measuring the size distribution of the sample before and after the fluid or chemical treatment. Utilities of size distribution measurement may include, but not limited to, laser particle size analyzer and sieve distribution, as known to the person with ordinary skill in the art.

The fluid or chemical used for treating samples of brittle particulate materials may be extended to any acids, bases, gases and other chemicals with which the sample may come in to contact during its service life. These may include, but not limited to, 12% HCl+3% HF acid, acids of variable concentration, bases of variable concentration, fracturing fluids, production fluids, crude oil, chemicals derived from crude oil, H₂S gas, CO₂ gas, sodium bicarbonate aqueous solution, phosphonate-based acids, polycarboxylic acids (PAA) and mixtures of these.

The fluid or chemical treatment may be carried out at an elevated temperature higher than room temperature. The fluid or chemical treatment may also be carried out for an extended period of time.

Single particle crush test is carried out on each and every particle for each of the eight sample portions, as described in the following paragraphs. In single particle crush tests, the diameter (D) of each particle that is not disintegrated in the eight samples was measured with a caliper of 0.01 mm resolution. Single particle crush test was done on a table-top mechanical tester which captures the ultimate load (F) at which the single particle breaks between two carbide anvils. For each and every one of the particles with measured diameter and corresponding ultimate load, its crush strength (σ) is calculated by Equation (1) (Luscher, et al., 2007; Couroyer, et al., 2000):

$$σ = \frac{2.8 F}{π {D}^{2}} \qquad ( 1 )$$

For each Sample portion, all the particles that maintained integrity after fluid treatment were crushed for total representation of the said Sample portion. The total number (I) was tallied and the data was analyzed by the two-parameter Weibull distribution (ASTM C1239-07). By indexing the obtained strength numbers from low to high into a series of (σᵢ) whereby the index i=1 . . . I, each particle's strength (σᵢ) was assigned a probability of failure (Pᵢ) calculated with Equation (2)

$${P}_{i} = \frac{i - 0.5}{I} \qquad ( 2 )$$

By plotting

$$lnln ( \frac{1}{1 - {P}_{i}} )$$

vs. lnσᵢ and linear regression, the Weibull modulus (m) can be obtained as the slope and characteristic strength (σ₀) from the intercept on the axis of lnσ. In this case, the Weibull distribution can be represented by Equation (3):

$$lnln ( \frac{1}{1 - {P}_{i}} ) = mln \frac{{σ}_{i}}{{σ}_{0}} \qquad ( 3 )$$

Equivalently, the probability density of single proppant particle strength can be deduced from Equation (3) as

$$\frac{d P}{d σ} = \frac{m {σ}^{m - 1}}{{σ}_{0}^{m}} exp [ - {( \frac{σ}{{σ}_{0}} )}^{m} ] \qquad ( 4 )$$

The outcome of the above Weibull distribution analysis of single particle crush tests is the Weibull modulus m and the characteristic strength (σ₀) which jointly represent the mechanical quality of the proppant sample. Examples of Weibull distribution analysis are demonstrated by A. Santra, et al. (2009).

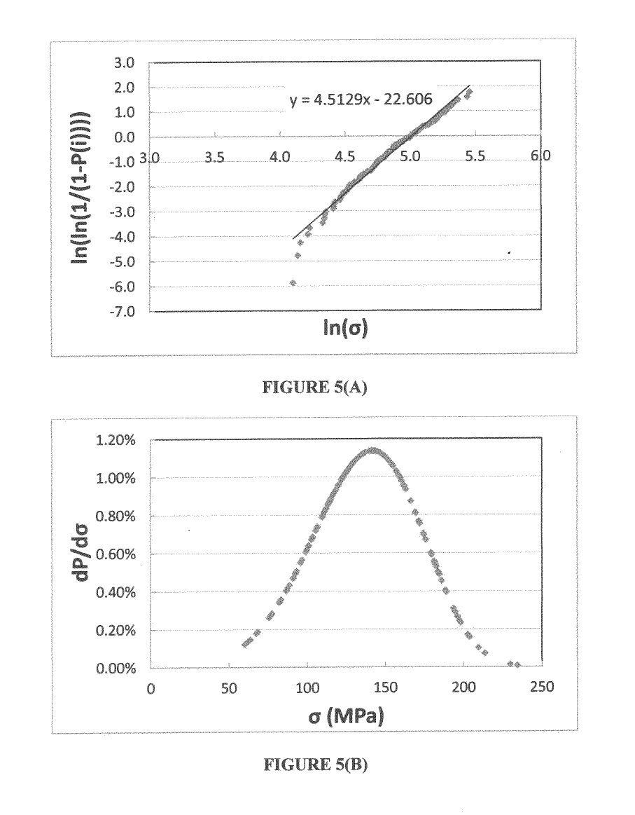

A typical Weibull analysis is shown in FIG. 5 for Sample D which had 179 particles in total. The linear regression of the 179 crush strength data points for all the 179 particles in Sample D shows a slope of 4.51 and an intercept of 5.009 (=22.606/4.5129) on the horizontal axis. So the Weibull modulus (m) is 4.51 and characteristic strength (σ₀) is 150 MPa (=exp(5.009)) for Sample D (Table 1). Once the Weibull modulus and characteristic strength is obtained, proppant single particle strength distribution can be plotted, as shown, in FIG. 5(B) for Sample D. Note that FIG. 5(A) and FIG. 5(B) are equivalent in that they are two different representations of the same data. The outcome of the above Weibull distribution analysis of single particle compression tests is the Weibull modulus m and the characteristic fracture strength σ₀ which jointly represent the fracture mechanical quality of the material of which the said single particles are made.

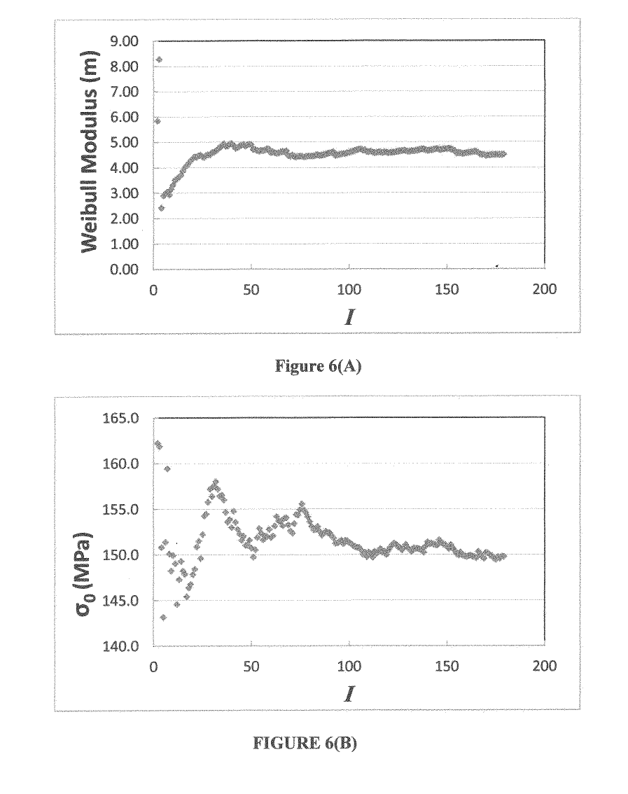

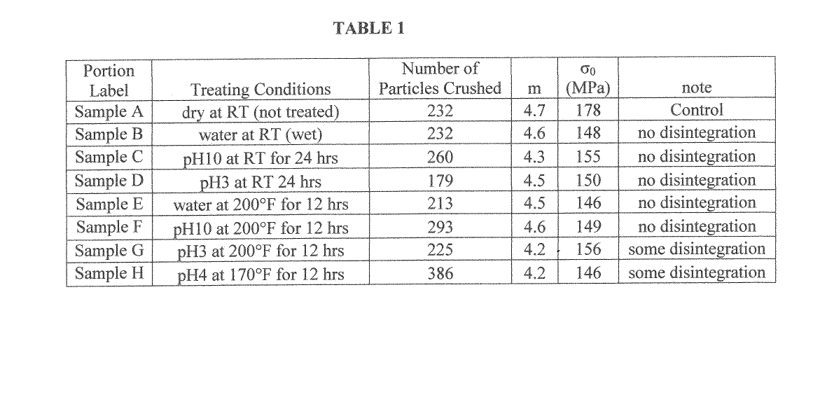

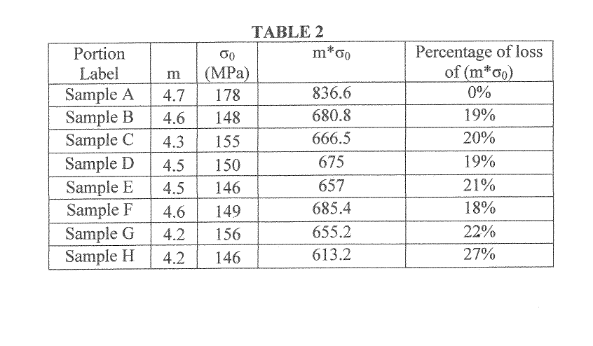

While crushing only a few particles is enough for linear regression, the few particles selected will likely yield unreliable test results because of small sample space. On the other hand, crushing all the particles in a proppant sample will give the most reliable result, but it could be too time-consuming. Weibull analysis is done for the first 2, 3, 4. 5, 6 . . . crushed proppant single particles and the plotted against the number of particles tested (I), as shown in FIG. 6 for Sample D. Up until the 30th particle, the Weibull modulus and characteristic strength have some variation (FIG. 6(A) and FIG. 6(B)). The variation becomes less when the number of proppant particles crushed reached 50˜100. When more than 100 particles were crushed, the Weibull modulus and characteristic strength converge to stable values (FIG. 6(A) and FIG. 6(B)). Other samples (Samples A, B, C, E, F, G and H) showed similar trend of stabilizing after crushing 50˜100 proppant particles (raw data not shown due to space limitation). It is hereby concluded that the number of proppant particles that ought to be crushed for consistent representation is around 100 for the proppant samples. Choosing only 20˜30 particles to crush seems inadequate for consistency.

When more than 100 particles are crushed, the amount of operator time rises accordingly. To make the test more efficient, it is practical to set an upper limit of the number of particles. It was found that such an upper limit may be 400, as indicated by Sample H. The reliable and practical range of the number of particles to be crushed may be 100 to 400, inclusive. Preferably the reliable and practical range of the number of particles to be crushed may be 100 to 200, inclusive.

As shown in Table 1, the results are compared for Samples B, C, D, E, F, G and H, which were all treated in aqueous liquids and crushed wet (with small water droplets) against Sample A (as control) which was crushed dry and represented the original Master Sample. All the samples treated with fluids have lower characteristic strength and are weaker than Sample A. All the samples treated with fluids have lower Weibull modulus and wider strength distribution than Sample A.

The product of Weibull modulus m and characteristic strength σ₀ (m*σ₀), as presented in Table 2, is a unified measure of the overall mechanical property of the samples, respectively. Compared with the control (Sample A), Samples B, C, D, E and F have a loss of (m*σ₀) in a narrow range of 18% to 21%. When samples are treated in acids at elevated temperatures (Samples G and H), the loss of (m*σ₀) become more significant, in addition to the disintegrated particles that are not accounted for in single particle crush tests. The unified measure of (m*σ₀) is an effective and simplified way to characterize the overall mechanical property of the particles crushed and the sample they represent.

Single proppant particle crush test is a consistent method for proppant strength evaluation in that it the Weibull modulus and characteristic strength both converge to stable values after a certain number of particles are crushed.

The current finding on the interaction between weakly acidic fluid and ceramic proppant could have important implications for proppant selection and industry standard for proppant quality control. On the one hand, a proppant material such as the Master Sample in this study should not be selected for sour or sweet wells that produce CO²/H₂S-containing fluids, nor can it be in contact with completion fluids with acidic scale inhibitors. On the other hand, the conventional acid solubility (per ISO13503-2 Standard) should be revised to include tests at moderate to weak acidity.

It is to be understood that many modifications, alterations, and changes can be made in the invention without departing from the spirit and scope of the invention as set forth in the appended claims. It is the intention to cover all embodiments and forms of the invention within the allowable scope of the claims.

I claim:

1. A method of testing brittle particulate materials, wherein a sample of the said brittle particulate material is characterized for particle disintegration after the said sample is treated with a fluid or chemical.

2. The method of characterizing particle disintegration according to claim 1, wherein imaging or visual observation is used for characterizing the particle disintegration.

3. The method of characterizing particle disintegration according to claim 1, wherein sieve distribution is used for characterizing the particle disintegration.

4. The method of characterizing particle disintegration according to claim 1, wherein a particle size analyzer is used for characterizing the particle disintegration.

5. The method of fluid treating according to claim 1, wherein the fluid or chemical may be an acid, a base, a gas or any fluid or chemical that simulates the chemistry of real-time fluids or chemicals.

6. A method of single particle crush test of brittle particulate materials, wherein then number of particles crushed falls in a range of 100 to 400, inclusive.

7. The method of single particle crush test of brittle particulate materials according to claim 6, viherein the said range is 100 to 200, inclusive.

8. A method of evaluating and ranking the mechanical quality of the brittle particulate materials by single particle crush tests, wherein the product of the Weibull modulus and the characteristic mechanical property is a unified quantity indicating the mechanical quality of the material of which the single particles are made.
